(19) United States
(12) Patent Application Publication
(10) Pub. No.: US 2008/0253241 A1
(43) Pub. Date: Oct. 16, 2008

(54) Optical pickup

(75) Inventors: Takashi Komori, Kanagawa-Ken (JP); Takanari Honda, Kanagawa-Ken (JP)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(73) Assignee: Victor Company of Japan, Ltd., Yokohama-shi (JP)

(21) Appl. No.: 12/082,324

(22) Filed: Apr. 10, 2008

(30) Foreign Application Priority Data
Apr. 11, 2007 (JP) JP 2007-103664

(51) Int. Cl. G11B 7/095

(52) U.S. Cl. 369/44.32

(57) ABSTRACT

An optical pickup includes an objective lens for focusing a light beam onto an optical disc surface, a bobbin for supporting the objective lens, the bobbin having a first side face and a second side face on the opposite side of the bobbin with respect to the first side face, a first pair of suspension wires and a second pair of suspension wires, each wire having a first end and a second end, each of the first pair of suspension wires being attached to the first side face of the bobbin at the first end, and each of the second pair of suspension wires being attached-to the second side face of the bobbin at the first end, and a base to which each of the first and second pair of suspension wires is attached at the second end, for supporting the bobbin so that the bobbin can swing on the base. The first and second pair of suspension wires are plated in accordance with at least one different plating requirement between the first pair of suspension wires and the second pair of suspension wires.

### CROSS-REFERENCE TO RELATED APPLICATIONS

This application is based on and claims the benefit of priority from the prior Japanese Patent Application No. 2007-103664 filed on Apr. 11, 2007, the entire content of which is incorporated herein by reference.

### BACKGROUND OF THE INVENTION

The present invention relates to an optical pickup. Particularly, this invention relates to an optical pickup that stably follows a rotating optical disc even though the disc is inclined, in an optical disc apparatus.

An optical pickup is installed in an optical disc apparatus in such a manner that an objective lens of the optical pickup can move over an optical disc in two directions: one for focusing in which the objective lens moves closer to or apart from the disc and another for tracking in which the objective lens moves along the radius of the disc, as disclosed, for example, in Japanese Un-examined Patent Publication No. 10 (1998)-269600.

Such a technique to the objective lens allows the optical pickup to follow a rotating optical disc in the two directions discussed above even though the disc suffers warpage or decentration.

Another technique to the objective lens is to keep the objective lens so that lens optical axis is always orthogonal to the disc surface even though an optical disc or a disc turntable is inclined, or suffers inclination in the radial direction.

Such a technique is disclosed, for example, in Japanese Un-examined Patent Publication No. 2002-197700. In this document, an objective lens is supported by four suspension wires: two located in the disc inner-circular side and the other two in the disc outer-circular side, with different spring constants for the former and latter wire pairs. The different spring constants are given to the suspension wires so that the objective lens can vary its angle with respect to the disc depending on the angle on surface inclination due to, for example, warpage. Such different spring constants can be given to the suspension wires with different diameters for spring materials of the wires.

Different spring constants can also be given to the suspension wires with different shapes or materials for spring materials of the wires, as disclosed, for example, in Japanese Un-examined Patent Publication No. 2007-66481.

Especially, optical disc apparatuses for use in recent higher-density optical discs, such as, DVD (Digital Versatile Disc) and Blu-ray Discs require a higher accurate mechanism that allows the objective lens to stably follow the rotating disc, with the lens optical axis constantly orthogonal to the disc surface even though the disc surface is inclined in the radial direction.

Achieving such a highly accurate mechanism with suspension wires having different spring constants by producing the wires with spring materials of different diameters is disadvantageous as discussed below.

The diameter of wire materials for the suspension wires varies within the specifications of the wire materials. The variation in diameter is remarkable among wire production lots rather than in each lot. This means that no matter how the wire diameter is precisely defined for obtaining a required spring constant, the diameter varies among the lots, and the spring constant varies accordingly.

It is therefore difficult to achieve such a highly accurate mechanism, discussed above, for the optical pickups, irrespective of the diameter variation among the wire production lots. One required process is the selection of wire materials that give a required spring constant among the lots. The unselected materials are of course useless.

Achieving such a highly accurate mechanism with suspension wires having different spring constants by producing the wires with different types of wire materials is also disadvantageous as discussed below.

The physical properties of wire materials vary among wire production lots, which leads to variation in spring constant among the lots.

It is also difficult to achieve such a highly accurate mechanism, discussed above, for the optical pickups over several wire production lots. One required process is the selection of wire materials that exhibit particular physical properties to give a required spring constant among the lots. The unselected materials are of course useless.

As discussed above, it is difficult to obtain a required spring constant accurately from among wire production lots with variation in wire diameter or physical properties.

### SUMMARY OF THE INVENTION

A purpose of the present invention is to provide an optical pickup in which an objective lens can accurately or stably follow a rotating optical disc while supported by suspension wires made of wire materials that exhibit required spring constants, selected among wire production lots.

The present invention provides an optical pickup comprising: an objective lens for focusing a light beam onto an optical disc surface; a bobbin for supporting the objective lens, the bobbin having a first side face and a second side face on the opposite side of the bobbin with respect to the first side face; a first pair of suspension wires and a second pair of suspension wires, each wire having a first end and a second end, each of the first pair of suspension wires being attached to the first side face of the bobbin at the first end, and each of the second pair of suspension wires being attached to the second side face of the bobbin at the first end, the first and second pair of suspension wires being plated in accordance with at least one different plating requirement between the first pair of suspension wires and the second pair of suspension wires; and a base to which each of the first and second pair of suspension wires is attached at the second end, for supporting the bobbin so that the bobbin can swing on the base.

### BRIEF DESCRIPTION OF DRAWINGS

FIG. 1 is a perspective view illustrating an embodiment of an optical pickup according to the present invention;

FIG. 2 is a schematic view illustrating the embodiment of the optical pickup according to the present invention;

FIG. 3 is a table showing variation in elastic modulus for suspension wires depending on the diameter of wire material and plating thickness; and

FIG. 4 is a schematic perspective view illustrating a modification to the embodiment of the optical pickup according to the present invention.

### DETAILED DESCRIPTION OF PREFERRED EMBODIMENT

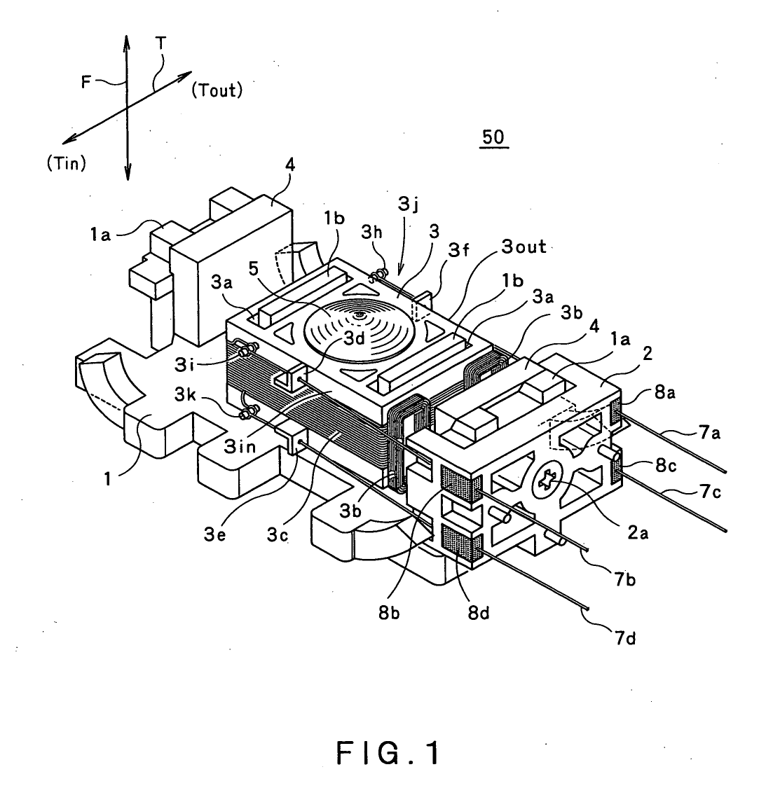

An optical pickup 50 shown in FIG. 1, a preferred embodiment of the present invention, moves an objective lens 5 in the directions of focus and tracking, indicated by arrows F and T, respectively, with respect to an actuator base 1.

The optical pickup 50 is installed in an optical disc apparatus (not shown) in such a manner that a sign Tin side of the pickup 50 in the tracking direction T is located as facing the inner side of an optical disc (not shown) while a sign Tout side of the pickup 50 in the direction T is located as facing the outer side of the disc, over the disc surface.

The actuator base 1 is installed in a housing (not shown) that contains optical components, such as, a laser source and a photoreceptor.

The actuator base 1 made of a pressed metal plate is provided with two pairs of skives 1a and 1b. Each skive 1a has a magnet 4 attached thereto with an adhesive. Each skive 1b faces the magnet 4 as being loosely fit in a through hole 3a of a bobbin 3 (which will be described later), thus providing a closed magnetic path.

Although not shown, a tap hole is provided at one of the skives la. A suspension base 2 is attached to this skive la with a screw 2a through the tap hole.

The bobbin 3 supports an objective lens 5. Wound around the bobbin 3 are a tracking coil 3b and a focus coil 3c. The bobbin 3 is produced as having protrusions 3h, 3i, 3j (not shown), and 3k by injection molding with thermosetting resin or thermoplastic resin that exhibits a high solder heat resistance.

Wound around the protrusions 3i and 3k are the coil end terminals of the focus coil 3c. Wound around the protrusions 3h and 3j are the coil end terminals of the tracking coil 3b. Soldered to the coil-wound portions of the protrusions 3i and 3k are suspension wires 7b and 7d, respectively. Soldered to the coil-wound portions of the protrusions 3h and 3j are suspension wires 7a and 7c, respectively.

The bobbin 3 with the structure described above are suspended by the two pairs of the suspension wires 7a and 7c, and 7b and 7d, extended in parallel from the suspension base 2, so that it can swing in the focus and tracking directions.

In order to suspend the bobbin 3 so that the bobbin 3 can swing in the focus and tracking directions, the suspension wires 7a to 7d are assembled as described below.

The two suspension wires 7b and 7d are extended from the suspension base 2 thorough holes of L-shaped protrusions 3d and 3e (formed on one side face of the bobbin 3), respectively. The extended wires 7b and 7d are soldered to the coil-wound portions of the protrusions 3i and 3k, respectively, around which the coil end terminals of the focusing coil 3c are wound.

The other two suspension wires 7a and 7c are extended from the suspension base 2 thorough holes of L-shaped protrusions 3f and 3g (not shown and formed on the other side face of the bobbin 3), respectively. The extended wires 7a and 7c are soldered to the coil-wound portions of the protrusions 3h and 3j (not shown), respectively, around which the coil end terminals of the tracking coil 3b are wound.

While being soldered to the protrusions 3h, 3j , 3i and 3k, the suspension wires 7a, 7c, 7b and 7d are fixed to the suspension base 2 with adhesives 8a, 8c, 8b and 8d, respectively.

Accordingly, the bobbin 3 with the structure described above is suspended by the suspension base 2 with the suspension wires 7a to 7d as the wires are attached to the base 2 at four corner of a rectangular surface of the base 2 with the adhesives 8a to 8d while soldered to the protrusions 3h to 3k.

When the suspension wires 7b and 7d are energized, the focus coil 3c is also energized, so that the bobbin 3 moves in the direction F, which leads to change in distance between the objective lens 5 and an optical disc (not shown), thus achieving focus control.

When the suspension wires 7a and 7c are energized, the tracking coil 3b is also energized, so that the bobbin 3 moves in the direction T and then the objective lens 5 traverses the tracks of the optical disc, thus achieving tracking control.

The optical pickup 50 is installed in an optical disc apparatus (not shown) so that a laser beam from a laser source (not shown) can be focused onto the data-recorded surface of the optical disc, in data recording or reproduction.

Disclosed next in detail is the suspension wires 7a to 7d used for suspending the bobbin 3 on the suspension base 2 so that the bobbin 3 can swing in the directions F and T, as discussed above.

In this embodiment, the wire materials are selected for the suspension wires 7a to 7d so that the wires 7b and 7d provided in the inner side of an optical disc exhibit a grater spring constant than the wires 7a and 7c provided in the outer side of the disc, over the disc surface.

The term “spring constant” discussed throughout the specification indicates how a suspension wire is hard to bend: a grater spring constant gives a higher hardness whereas a smaller spring constant gives a lower hardness to a wire to bend.

The ratio of spring constant is 1:0.9 for the suspension wires 7b and 7d to 7a and 7c, in this embodiment.

Disclosed below are three examples A to C for obtaining 1:0.9, the ratio of spring constant.

### EXAMPLE A

Prepared for the suspension wires 7a to 7d are wire materials made of copper beryllium with almost equal diameter and quality selected from the same lot. The wire materials are plated with tin at different thicknesses: thinner for the wires 7a and 7c located in the outer side of an optic disc in the direction T in FIG. 1 than the wires 7b and 7d located in the inner side of the optic disc, over the disc surface.

The plating thickness adjustments give variation in the spring constant so that the outer suspension wires 7a and 7c are more bendable than the inner wires 7b and 7d.

### EXAMPLE B

Prepared for the suspension wires 7a to 7d are wire materials made of copper beryllium with almost equal diameter and quality selected from the same lot.

The wire materials are plated at the same thickness but with different metals of a lower Young's modulus for the outer suspension wires 7a and 7c than the inner wires 7b and 7d: tin with about 49,900 (N/mm²) in Young's modulus for the outer wires 7a and 7c; and gold with about 80,000 (N/mm²) in Young's modulus for the inner wires 7b and 7d.

The Young's modulus adjustments to the metals for plating give variation in the spring constant so that the outer suspension wires 7a and 7c are more bendable than the inner wires 7b and 7d.

### EXAMPLE C

This is the combination of the examples A and B.

Prepared for the suspension wires 7a to 7d are wire materials made of copper beryllium with almost equal diameter and quality selected from the same lot.

The wire materials are plated with at different thicknesses: thinner for the outer suspension wires 7a and 7c than the inner wires 7b and 7d, with deferent metals: gold for the outer wires 7a and 7c; and tin for the inner wires 7b and 7d.

In the example C, different from the example B, the metal used in plating the inner wires 7b and 7d exhibits a lower Young's modulus than for the outer wires 7a and 7c.

In addition to the Young's modulus adjustments, the example C employs the plating thickness adjustments that give variation in the plated thickness, which variation is grater than the variation in Young's modulus for giving a smaller spring constant to the outer suspension wires 7a and 7c than the inner wires 7b and 7d so that the wires 7a and 7c are more bendable than the wires 7b and 7d.

The examples B and C employ tin and gold in plating the wire materials to achieve variation in Young's modulus. Another reason for employing tin and gold is that these metals give different colors to the surfaces of the plated wire materials, which allows easy discrimination among the plated suspension wires for their spring constants. It is, thus, preferable to select metals that give different colors to the wire materials in plating in obtaining variation in spring constant with different materials.

As disclosed above, the examples A to C employ plating in adjustments to the spring constant of wire materials.

For the spring-constant adjustments, several sample wire materials are selected from each wire production lot. The samples are plated and their Young's modulus are measured for adjustments to plating requirements per lot to achieve required Young's modulus.

The adjustments to the plating requirements per wire production lot allow production of suspension wires with desired spring constants irrespective of variation among wire production lots. Moreover, the adjustments do not require selection of wire materials among the lots, thus decreasing the number of processes and allowing all wire materials to be used.

The examples A to C require that the wire materials be of almost equal diameter and quality for the suspension wires 7a to 7d. The diameter or quality may, however, be different between the outer wires 7a and 7c, and the inner wires 7b and 7d. The essential requirement in the examples A to C is the wire plating for achieving required spring constants.

The following example D employs wire materials with different diameters between the outer suspensions wires 7a and 7c, and the inner wires 7b and 7d.

### EXAMPLE D

Prepared for the suspension wires 7a to 7d are wire materials made of copper beryllium at a diameter ratio of about 1:0.96 for the inner wires 7b and 7d to the outer wires 7a and 7c. The diameters are 94.8 μm and 88.8 μm for the inner wires 7b and 7d, and the outer wires 7a and 7c, respectively.

The inner suspension wires 7b and 7d are plated with tin at 0.60 μm. The outer wires 7a and 7c are plated with gold at 0.16 μm. The diameters of the plated wires 7b and 7d, and 7a and 7c are 96.0 μm and 92.0 μm, respectively.

The diameter adjustments give a particular spring constant to the inner suspension wires 7b and 7d, which is about 10% higher than the outer wires 7a and 7c.

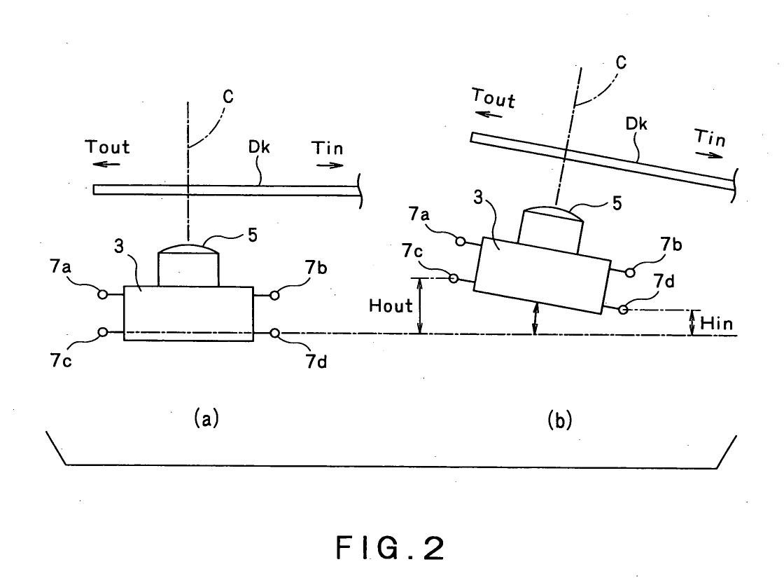

The optical pickup 50 with the structure described above can follow a rotating disc, with the optical axis of the pickup 50 always orthogonal to the disc surface, even though the disc is inclined, as illustrated in FIG. 2.

Illustrated in (a) and (b) of FIG. 2 is that an optical disc Dk is not inclined and is inclined, respectively.

In the optical pickup 50 in (a) of FIG. 2, the bobbin 3 is supported by the suspension wires 7a to 7d so that an optical axis C of the objective lens 5 always stays as orthogonal to the optical disc Dk that is not inclined.

As disclosed above, in the optical pickup 50, the suspension wires 7a and 7c located in the outer side (Tout) of the optical disc Dk has a smaller spring constant than the wires 7b and 7d located in the inner side (Tin) of the disc Dk, over the disc surface.

Therefore, when the optical disc Dk is inclined, as illustrated in (b) of FIG. 2, the outer suspension wires 7a and 7c can bend at a higher level Hout than the inner wires 7b and 7d at a level Hin.

As discussed, with the focus and tracking control described above, in addition to the movements in the direction F (FIG. 1) in which the objective lens 5 moves closer to or apart from the optical disc Dk, the lens 5 can be inclined in a dock-wise direction in FIG. 2 to follow the rotating disc Dk so that the an optical axis C of the lens 5 always stays as orthogonal to the disc surface even though the disc Dk is inclined.

In the examples described above, the variation in the diameter of wire materials among wire production lots is about 4.5% at maximum.

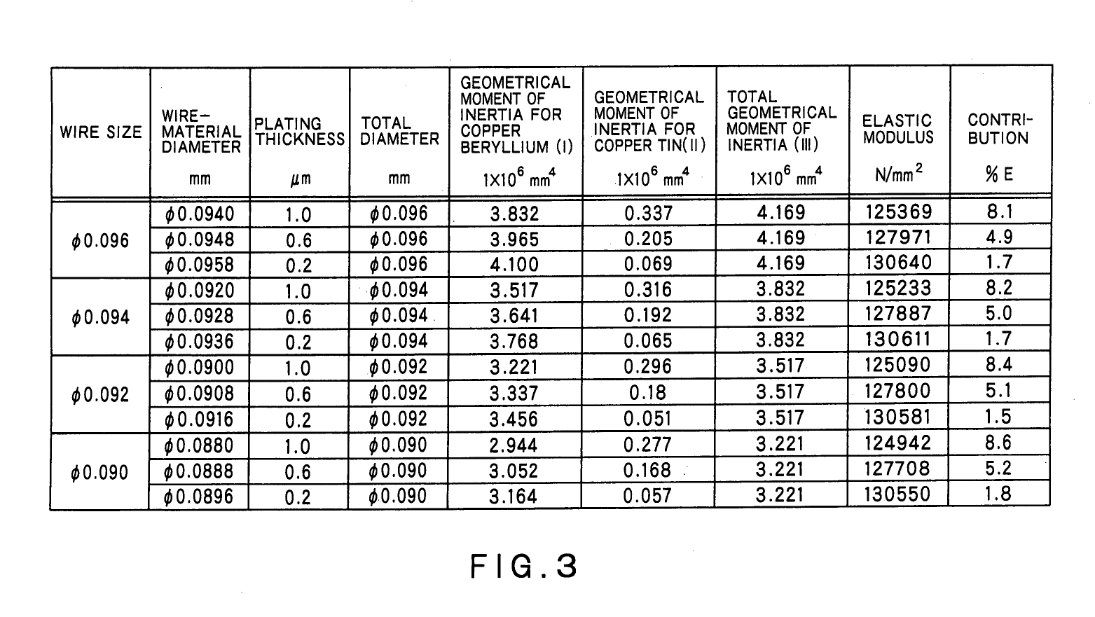

Discussed with reference to FIG. 3 is a table showing the variation in elastic modulus for suspension wires depending on the diameter of wire material and plating thickness.

The suspension wires listed in FIG. 3 were made of copper beryllium (the wire material) and applied with copper-tin plating in examination of the variation in elastic modulus.

In detail, listed in FIG. 3 are as follows:

WIRE SIZE: four different diameters for the suspension wires;

WIRE-MATERIAL DIAMETER: three different diameters for copper beryllium for each diameter of the suspension wires;

PLATING THICKNESS: the thickness of plated tin for each suspension wire to mitigate the diameter difference of the wire materials;

TOTAL DIAMETER: the total of the wire-material diameter and plating thickness for each suspension wire;

GEOMETRICAL MOMENT OF INERTIA FOR COPPER BERYLLIUM (I): the round-bar geometrical moment of inertia calculated for copper beryllium before plated;

GEOMETRICAL MOMENT OF INERTIA FOR COPPER TIN (II): the pipe geometrical moment of inertia calculated for plated copper tin (with no copper beryllium included);

TOTAL GEOMETRICAL MOMENT OF INERTIA (III): the total of the round-bar and pipe geometrical moment of inertia;

ELASTIC MODULUS: the elastic modulus of each suspension wire obtained by EMB×(I/III)+EMT×(II/III), in which EMB is the elastic modulus of beryllium that is 132,000 N/mm², and EMT is the elastic modulus of tin that is 49,900 N/mm²; and

CONTRIBUTION: the contribution ratio (II/III) calculated for indicating how much the plating contributes to the total of the round-bar and pipe geometrical moment of inertia.

FIG. 3 shows that the contribution ratio is lower than 9% for the plating to contribute to the total of the round-bar and pipe geometrical moment of inertia, thicker plating giving higher contribution ratio.

The table in FIG. 3 teaches that, even though, the variation in the diameter of wire materials is, for example, 4.8% among wire production lots, the plating described in the examples A to D can substantially nullify the diameter variation to obtain suspension wires of desired Young's modulus.

The examples A to D described above achieve variation in the spring constant between the inner and outer suspension wires in accordance with the plaiting requirements, that is, the plaiting thickness or the type of the metal to be used in plaiting.

In addition to the plaiting requirements, the variation in the spring constant can be achieved with variation in the hardness of dampers that are provided in the vicinity of the sections of the suspension base 2 where the suspension wires 7a to 7d are fixed with an adhesive.

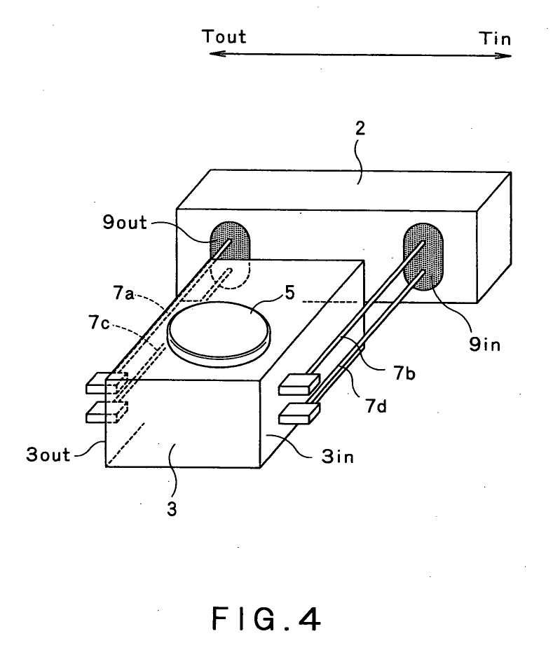

Such an example is described with reference to FIG. 4. The components in FIG. 4, the same as or analogous to those shown in FIGS. 1 and 2, are given the same reference numerals.

As illustrated in FIG. 4, the suspension wires 7b and 7d are fixed to a side face 3in of the bobbin 3, equipped with the objective lens 5, at one end of each wire. The side face 3in is located in the inner side Tin of an optical disc (not shown), over the disc surface. The suspension wires 7a and 7c are fixed to a side face 3out of the bobbin 3 at one end of each wire. The side face 3out is located in the outer side Tout of the disc, over the disc surface.

In the same way as the examples A to D, the suspension wires 7a to 7d are plated so that the outer wires 7a and 7c exhibit a smaller spring constant than the inner wires 7b and 7d.

The other end of each of the suspension wires 7a to 7d fixed to the suspension base 2 with an adhesive, via a damper 9in or 9out attached to the base 2, that is an elastic component such as a rubber. Each wire penetrates into the damper 9in or 9out to be protected from deformation.

The dampers 9in and 9out are formed as exhibiting different hardness: higher hardness to the damper 9in at the inner side Tin than the damper 9out at the outer side Tout.

In addition to the variation in the spring constant for the suspension wires 7a to 7d, the variation in the hardness of the dampers 9in and 9out allows the bobbin 3 to be easily inclined whenever the optical disc (not shown) is inclined so that the objective lens 3 can follow the rotating disc more precisely.

Moreover, in addition to the variation in the spring constant for the suspension wires 7a to 7d, the inclination of the bobbin 3 can be achieved with positional adjustments to the magnet 4 and a yoke (not shown) in the tracking direction in FIG. 1 to control the magnetic balance.

The above three measures: the variation in spring constant for the suspension wires; the variation in hardness for the dampers; and the magnetic-balance control can be combined in any way, for inclination of the bobbin 3.

As disclosed above in detail, the present invention provides an optical pickup that can follow a rotating optical disc in a precise manner even though the disc is inclined, irrespective of wire production lots from which wire materials are selected for suspension wires of the optical pickup.

It is further understood by those skilled in the art that the foregoing description is a preferred embodiment and several examples of the disclosed device and that various changes and modifications may be made in the invention without departing from the sprit and scope thereof.

What is claimed is:

1. An optical pickup comprising:
an objective lens for focusing a light beam onto an optical disc surface;
a bobbin for supporting the objective lens, the bobbin having a first side face and a second side face on the opposite side of the bobbin with respect to the first side face;
a first pair of suspension wires and a second pair of suspension wires, each wire having a first end and a second end, each of the first pair of suspension wires being attached to the first side face of the bobbin at the first end, and each of the second pair of suspension wires being attached to the second side face of the bobbin at the first end, the first and second pair of suspension wires being plated in accordance with at least one different plating requirement between the first pair of suspension wires and the second pair of suspension wires; and
a base to which each of the first and second pair of suspension wires being attached at the second end, for supporting the bobbin so that the bobbin can swing on the base.

2. The optical pickup according to claim 1, wherein the plating requirement is plating thickness.

3. The optical pickup according to claim 1, wherein the plating requirement is the type of metal used in plating.

4. The optical pickup according to claim 3, wherein metals used for plating exhibit different colors when applied to the first pair of suspension wires and the second pair of suspension wires.

5. The optical pickup according to claim 1, wherein the plating requirement is a combination of plating thickness and the type of metal used in plating.

6. The optical pickup according to claim 1 further comprising a first damper and a second damper attached to the bobbin, each of the first pair of suspension wires being attached to the first side face of the bobbin at the first end via the first damper, and each of the second pair of suspension wires being attached to the second side face of the bobbin at the first end via the second damper, the first and second damper exhibiting different hardness.
